(19) United States
(12) Patent Application Publication
(10) Pub. No.: US 2002/0125665 A1
(43) Pub. Date: Sep. 12, 2002

(54) Rollable support for luggage

(76) Inventor: Fred Cohen, North Hollywood, CA (US)

Correspondence Address: Roger A. Marrs, Suite 1220, 15233 Ventura Blvd., Sherman Oaks, CA, 91403, US

(21) Appl. No.: 10/093,750

(22) Filed: Mar. 8, 2002

Related U.S. Application Data
(60) Provisional application No. 60/275,085, filed on Mar. 12, 2001.

(51) Int. Cl. B62B 1/00

(52) U.S. Cl. 280/35; 280/47.26

(57) ABSTRACT

A rollable support assembly for luggage includes a pair of longitudinal adjustable in length supports having ends terminating in curved end portions so that the major length of the supports rests against the underside of the luggage while the end portions wrap around the corners of the luggage. Additionally, a pair of transverse cross braces which are adjustable in length and incorporate a separate end piece at one end that fits around the luggage corner to terminate adjacent the side thereof. One end of each brace rollably supports a swivel wheel while the opposite end supports a wheel having a fixed axis. Fastening means are employed for fixly securing the supports and the braces to the luggage in appropriate areas such as when the luggage is hard or soft and has a rigid bottom, rigid or soft sides, or a combination of both. Spacers accommodate fitting of the component parts to the luggage. The supports may be placed inside the luggage with the wheeled braces carried on the outside thereof.

### BACKGROUND OF THE INVENTION

1. Field of the Invention

The present invention relates to the field of wheeled luggage and more particularly to a novel rollable support assembly adapted to be built into original manufactured luggage as well as adapted to be mounted on existing or conventional luggage for the after market.

2. Brief Description of the Prior Art

In the past, it has been the conventional practice to manufacture luggage with a plurality of wheels on the underside or on a selected end of a piece of luggage whereby the luggage may be rolled in either a flat position or in a tilted position by means of an extendable handle or strap. In general, the conventional piece of luggage is provided with a bottom frame or an end frame to which wheels are attached. The frame, in turn, is built into the sides or bottom of the luggage piece at the factory and the luggage is distributed for sale after completion. The wheels are fixed on the frame and cannot be changed or relocated.

Problems and difficulties have been encountered with such conventional pieces of luggage which stem largely from the fact that after manufacturer, a user of the luggage may wish to add wheels to either end or to the bottom so that the luggage becomes more versatile in usage. Also, when the wheels and support therefor are incorporated into original equipment manufacturing, the frame, support or mount for the wheels, are of a fixed length and width and are not adapted for interchangeability with different lengths and widths of luggage. Difficulties have also been encountered when trying to incorporate wheels on the end of luggage or on the bottom of luggage because some luggage incorporates bottoms and sidewalls which are of soft material while other luggage incorporates a hard bottom with soft sides and top, while still other pieces of luggage are completely composed of hard sides, bottom and top.

Therefore, a long-standing need has existed to provide a rollable support assembly including wheels that may be incorporated into conventional luggage after initial manufacture of the luggage or which can be incorporated directly into the luggage by the original manufacturer and regardless of whether the luggage is the hard luggage type, the soft luggage type, or soft luggage with a hard bottom. The rollable support assembly including wheels should permit the luggage to be pulled or drawn in a flat orientation or in a tilted orientation and should be adjustable in length to accommodate different sizes of luggage containers.

### SUMMARY OF THE INVENTION

Accordingly, the above problems and difficulties are avoided by the present invention which provides a novel rollable support assembly for luggage which includes a pair of elongated longitudinal adjustable supports having opposite ends that are curved and terminate in arcuate end portions so that the major length of each support rests against the underside or bottom of the luggage while the ends portions wrap around the opposite end corners of the luggage. Additionally, a pair of transverse cross braces are provided which are adjustable in length and which incorporate a separate arcuate end piece at one end of each brace that fits around the luggage end corner to terminate adjacent the side thereof. One end of each brace rollably supports a swivel wheel while the opposite end of each brace supports a wheel having a fixed axis. Fastening means are employed for fixly securing the support and the braces to the piece of luggage in appropriate areas regardless of whether the luggage has a rigid bottom, rigid or soft sides, or a combination of both.

A feature of the invention resides in providing spacers between respective components of the braces and the supports so as to accommodate fitting of the component parts to the luggage. Also, it is to be understood that the pair of supports are arranged parallel with respect to each other and may be placed inside the luggage or case with the wheeled braces carried on the outside of the case. Alternatively, both the supports and the braces may be installed on the outside of the case. Adjustment in length for both the supports and the braces may take the form of a telescoping bar and slot arrangement or the like.

Therefore, it is among the primary objects of the present invention to provide a novel rollable support assembly with wheels for permitting luggage to be rolled in a flat orientation or in a tilted orientation and whereby the rollable support assembly can be added to existing or conventional luggage as a retrofit or after market modification.

Another object of the present invention is to provide a novel rollable support assembly for luggage which includes parallel supports and parallel braces that are adjustable in length and may be retrofitted onto existing or conventional luggage in order to increase the versatility of usage.

Another object of the present invention is to provide a novel rollable support for standard luggage whether the standard luggage is known as hard luggage, soft luggage, or soft luggage with a hard bottom. Such rollable support may include swivel wheels as well as wheels having a fixed axis.

Yet a further object of the present invention is to provide a novel rollable support assembly for luggage that is adjustable for accommodating mounting onto conventional luggage employing support that can be incorporated inside the luggage or outside the luggage depending on whether the luggage is of the hard type, soft type with hard sides, or considered soft luggage with a hard bottom.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a bottom perspective view showing the novel rollable support assembly including wheels for mounting onto conventional luggage in accordance with the present invention;

FIG. 2 is a transverse cross-sectional view of the luggage and rollable support assembly shown in FIG. 1 as taken in the direction of arrows 2-2 thereof;

FIG. 3 is a perspective view of a transverse brace showing adjustability as used in the support mounting assembly of FIG. 1;

FIG. 4 is an enlarged fragmentary view, in section, of a fastener used in securing the brace and support of the present assembly as shown in FIG. 1 as taken in the direction of arrow 4-4 thereof;

FIG. 5 is an exploded view of the fastener preparatory for joining the braces and support to the luggage; and

FIG. 6 is an enlarged transverse cross-sectional view of an adjustable means for lengthening or shortening a support or brace.

### DESCRIPTION OF PREFERRED EMBODIMENT

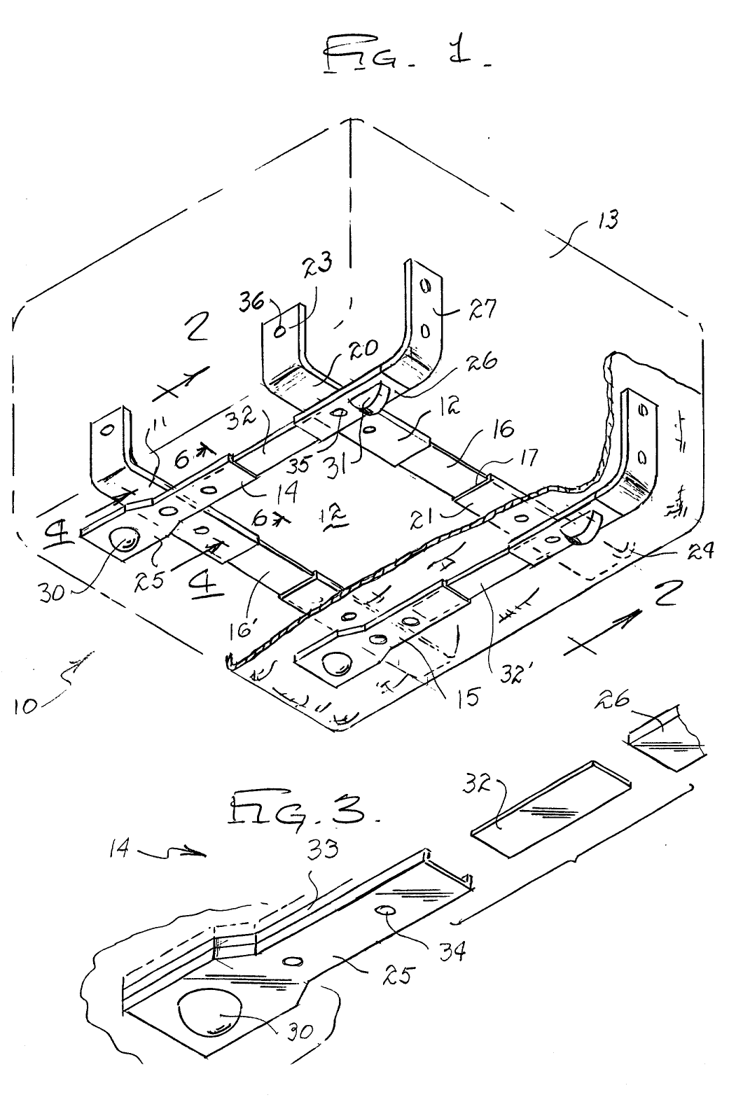

The rollable support assembly for luggage is indicated in FIGS. 1 and 2 in the general direction of arrow 10 and is illustrated in connection with a standard or conventional piece of luggage shown in broken lines and identified by numeral 13. The rollable support represents an assembly having a pair of support members which are elongated and are adjustable in length and which are further arranged in fixed, parallel spaced-apart relationship on the underside or bottom 19 of the luggage 13. In addition to the support members 11 and 12, a pair of brace members broadly identified by numerals 14 and 15 are also arranged in fixed, parallel spaced-apart relationship on the underside or bottom of the luggage 13. The support members and brace members are perpendicular with respect to one another and each is adjustable in length. Adjustability for each support member includes an element or slug 16 and 16′ respectively having its opposite end insertably received into channels such as channel 17 provided on the opposite end of support member elements 20 and 21. The other end of each element 20 and 21 terminates in a 90° curve to form end sections 23 and 23′.

The brace members 14 and 15 include sections 25 and 26. Only section 26 of each brace member includes an end piece 27 and 27′ which is curved and extends outwardly in a cantilevered fashion from the end of each section 26. It is also to be noted that each of the respective sections 25 and 26 include wheels such as a swivel wheel 30 operatively carried on section 25 and a wheel 31 having a fixed axis carried on section 26. A slug 32 has its opposite ends insertably received into channels at the opposite ends of section 25 and 26 in a similar fashion to that previously described with respect to element or slug 16.

Construction in this manner permits the length of the respective support members and brace members to be lengthened or shortened in order to fit the width and/or the length of the luggage 13 to which it is attached. It is also to be understood that in the case of luggage with a hard bottom, the brace members 14 and 15 may be readily attached to the hard bottom without the necessity of the support members 11 and 12. However, when soft luggage is employed, the support members 11 and 12 are placed on the inside adjacent to the soft bottom of the luggage and the brace members are placed on the outside of the luggage. Also, it is to be noted that the sections or end pieces 27 are only used when it is desired to attach the brace members to a rigid structure such as hard sides of luggage 13 when such hard sides are available. It can also be seen that each of the respective support members and brace members include open apertures through which fasteners can be placed in order to secure the respective components to each other and to the luggage 13.

Referring now in detail to FIG. 3, brace member 14 is more clearly illustrated and it can be seen that a plurality of spacers such as spacer 33 may be placed under the respective sections 25 and 26 so as to raise the brace member to an appropriate height. A plurality of spacers can be used to achieve adjustment. Also, the channels at the end of the respective sections and elements is more clearly illustrated for

insertably receiving the opposite ends of a slug such as the adjustment slug 32. Also, an opening such as opening 34 is available on all of the sections and elements of the assembly for accepting retaining fasteners.

Referring now in detail to FIG. 2, a completed assembly is illustrated in cross section for hard luggage, as an example, wherein the luggage 13 includes hard sides and a hard bottom 19. It can be seen that the respective support members 20 and 21 are placed on the inside of the luggage while the brace members 26 and 26′ are carried on the outside of the luggage. Fasteners for securing the braces, such as brace member 14, to the hard bottom of the luggage or to the soft bottom in connection with the internal support members 11 and 12 are represented by numeral 35. The end piece or element 23 illustrates attachment to the side of the luggage by means of a fastener 36.

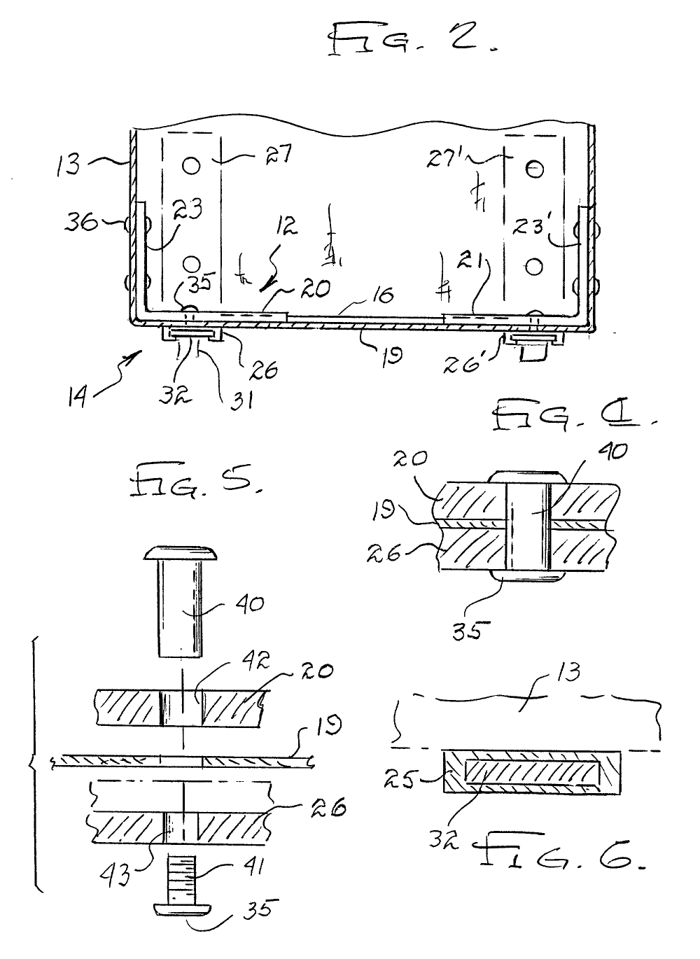

In FIGS. 4 and 5, it can be seen that a fastener 35 is inserted into a barrel 40 that has an internal threaded bore for threadably receiving a threaded shank 41 of the screw fastener 35. The barrel 40 is passed through openings such as opening 42 in support section 20 while the threaded shank 41 is inserted through hole 43 in the brace section 26. When secured together, the brace members and support members are drawn together on opposite sides of the hard bottom or soft luggage bottom 13.

In FIG. 6, it can be seen that the adjustment slug 32, as an example, is insertably received into a channel or opening provided in the opposing ends of each of the respective sections of the brace members and support members such as sections 25 and 26 associated with brace member 14.

In view of the foregoing, it can be seen that the brace members may be used separately in order to put a wheeled assembly on the outside of luggage so that the luggage may be pulled in a flat orientation. Four wheels are provided in order to support the luggage in a flat, rollable condition. Such an arrangement is suitable when hard luggage or luggage having a hard bottom is employed so that the brace members can be readily attached to the hard bottom of the luggage by the fasteners. On the other hand, if the luggage is soft, the support members 11 and 12 are placed on the inside against the bottom of the luggage while the brace members are placed on the outside and the entire assembly is joined to the luggage by the respective fasteners. During installation of the support members and/or the brace members, adjustment in length is readily available by use of the adjusting slug or any other suitable adjustment means for changing length. Spacers can be provided in order to compensate for height when placed on the underside of the luggage. In view of the foregoing, it can be appreciated that assembly of the brace members and/or the support members can be achieved as a retrofit and need not be incorporated into original luggage manufacturing. However, the invention is suitable for original equipment manufacturing, if desired.

Features of usage for the present invention resides in luggage that can be transported in a flat orientation or the luggage may be tilted on the fixed axis wheels. A suitable strap or handle can be included on the piece of luggage as is the usual practice. Also, it is to be noted that the brace members also serve as slide members when it is desired to pull the luggage upstairs so that the edge of a stair will ride along the exposed outer surface of the brace members when the wheels are not in contact with the flooring or portions of the stairs. Also, the end pieces 23 readily support the support members against the ends of the luggage. However, the element 27 carried on one end of the respective brace members serves as a slide when the luggage is transported in a tilted manner on the fixed wheels 31.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A rollable support assembly for luggage comprising:
a pair of brace members arranged in fixed, spaced-apart parallel relationship;
each of said brace members having end sections separated by a joining element to provide an elongated unitary construction;
said joining element adapted to adjustably connect said end sections together to provide an overall length;
a swivel wheel operably carried on a selected one of said end sections and a fixed axis wheel on a non-selected end section; and
said brace members capable of rollably supporting luggage in either a tilting orientation or a flat orientation.

2. The assembly as defined in claim 1 wherein:
each of said non-selected end sections includes an arcuate member extending at a right angle thereto and projecting along the opposite sides of luggage.

3. The assembly as defined in claim 2 including:
a plurality of fasteners securing said brace members to a bottom of luggage.

4. The assembly defined in claim 3 including:
a pair of support members arranged in fixed, spaced-apart parallel relationship and further arranged to couple with said pair of brace members with said support members being normal to said brace members; and
fastener means securing said support members and said brace members together in a one-piece construction.

5. The assembly defined in claim 4 wherein:
each of said support members includes end sections joined together by an adjustment means for selectively lengthening and shortening each of said support members.

6. The assembly defined in claim 5 wherein:
luggage is rollably supported by said brace members and said luggage is composed of hard or soft materials or combinations thereof.
